(19) United States
(12) Patent Application Publication
(10) Pub. No.: US 2023/0006988 A1
(43) Pub. Date: Jan. 5, 2023

(54) METHOD FOR SELECTIVELY EXECUTING A CONTAINER, AND NETWORK ARRANGEMENT

(71) Applicant: EBERHARD KARLS UNIVERSITÄT TÜBINGEN, Tübingen (DE)

(72) Inventors: Michael Menth, Tübingen (DE); Frederik Hauser, Stuttgart (DE); Mark Schmidt, Tübingen (DE); Julian Rilli, Langenau (DE)

(21) Appl. No.: 17/610,579

(22) PCT Filed: May 13, 2020
(86) PCT No.: PCT/EP2020/063328

§ 371 Date: Sep. 9, 2022

(30) Foreign Application Priority Data
May 13, 2019 (DE) 10 2019 112 485.9

(51) Int. Cl. H04L 9/40; H04L 61/5007

(52) U.S. Cl. CPC H04L 63/083; H04L 63/20; H04L 61/5007; H04L 63/10

(57) ABSTRACT

The invention relates to a method for selectively configuring a container that contains an application, wherein user-authentication data are received by a container management component and forwarded via a container applicant to an authorisation server. This server transmits an authorisation response, on the basis of which a decision is made as to whether the application is allowed to be run in the container.

### CROSS REFERENCE TO REPLATED APPLICATIONS

This application is the U.S. National Phase Application of PCT International Application No. PCT/EP2020/063328, filed May 13, 2020, which claims priority to German Patent Application No. 10 2019 112 485.9, filed May 13, 2019, the contents of such applications being incorporated by reference herein.

### FIELD OF INVENTION

The invention relates to a method for selectively executing a container that contains an application. The invention additionally relates to an associated network arrangement.

### BACKGROUND OF THE INVENTION

The problem considered herein is generally that of permitting users to execute specific applications on managed hosts and providing them with access to protected network resources. The prior art certainly discloses the practice of executing applications in containers in order to achieve a certain amount of separation from other applications or operating system components. However, further security and access control mechanisms have been lacking to date.

### SUMMARY OF THE INVENTION

Therefore an aspect of the invention to provide a method for selectively executing a container that contains an application, said method being alternative or improved in comparison with known embodiments. It is furthermore an aspect of the invention to provide an associated network arrangement. This is achieved according to an aspect of the invention by a method and a network arrangement according to the respective main claims. Advantageous configurations can be taken from the respective subclaims, for example. The content of the claims is made the content of the description by means of express reference.

An aspect of invention relates to a method for selectively executing a container that contains an application, wherein the method comprises the following steps:
a container management component receiving user authentication data,
the user authentication data being forwarded to a container supplicant,
the container supplicant transmitting an authorization request to an authorization server, wherein the authorization request contains at least the user authentication data,
the container supplicant receiving an authorization response from the authorization server, wherein the authorization response contains at least clearance information that can assume either a positive or a negative value,
the authorization response being forwarded to the container management component,
the container management component deciding whether the container can be executed, wherein the container can be executed if the clearance information has a positive value, and wherein the container cannot be executed if the clearance information has a negative value,
only if the container can be executed, the container being started and executed.

The method according to an aspect of the invention allows a user to be authorized by an authorization server, which is typically available centrally for a multiplicity of users. This means that various users can be managed centrally, users being able to be authenticated by the authorization server for example by accessing identity management servers such as LDAP. Security functions such as in particular authorization or preventing the execution of a container can be provided, which are not possible in embodiments based on the prior art.

An application, in the case of the method, is typically an integral part of a container. A container can be regarded as an application with dependencies. The application is typically executed in the container, which is a suitable environment for the application. Other components of an operating system are typically separated from the application by the container. By way of example, the container can provide interfaces by means of which the application can access certain resources of the operating system. This allows such access to be controlled and to be stopped in the absence of permission.

User authentication data can be a combination of a username and a password, for example. Other embodiments of user authentication data are also possible, however. The user authentication data can for example be entered manually via a user interface or can originate from an automatic or semiautomatic user authentication, for example by means of a card or fingerprint recognition, which allows for example user authentication data to be read in an automated manner from a safe or other store created for that purpose.

The container management component is typically a software component that performs management tasks for the container and typically runs outside the container. By way of example, it can start, stop and/or allocate resources to the container. The container supplicant is typically a software component that runs outside the container and communicates directly or indirectly with external components such as for example the authorization server, for example in order to perform the functionalities described. The authorization request can also contain further data in addition to the user authentication data, for example data that are described in more detail later. The authorization response can likewise also contain further information in addition to the clearance information, for example information that is described in more detail later. The clearance information may for example be realized in the form of a bit that can assume two states, each of which is associated with a positive or negative value. Starting of the container containing the application can in particular be prompted by the container management component.

It should be mentioned that the method as described hitherto can, in principle, be performed on only one electronic component such as for example a computer or a host. By way of example, it can also be performed in a virtual host, as provided by large computer centers, for example. The method involves communicating with components that may be external thereto, for example with the authorization server. Such components may for example be located in the same network and accordingly communicate with one another via the network. The text below also describes steps that need to be carried out on external components such as for example the authorization server. In this case, it will be understood that the method relates to an arrangement that can also contain multiple components.

According to a preferred embodiment, the authorization server determines the clearance information at least on the basis of the user authentication data. This makes it possible to guarantee that only users that have correct user authentication data can execute the application in the container. By way of example, the authorization server can compare the user authentication data against a database of approved users.

There may in particular be provision for the authorization server to compare the user authentication data with a number of user preset values and to set the clearance information to a positive value only if the user authentication data are consistent with one of the user preset values. This allows the user preset values to be used to easily stipulate which users have permission to execute the container. By way of example, the user preset values can be stored on the authorization server or can also be obtained externally. There may be provision for the clearance information to be, in principle, set to a positive value if the user authentication data are consistent with one of the user preset values. However, there may also be provision for further criteria that need to be satisfied for this purpose. By way of example, the container can also be authenticated, as described later.

Data being consistent with preset values can be understood, in principle, to mean that the data are exactly identical to the preset values, or that the data are in a certain relationship with the preset values. Such a relationship can be predefined as an equation or algorithm, for example.

According to a preferred embodiment, the authorization response additionally contains authentication information. Said authentication information can be generated by the authorization server or a component cooperating therewith, for example. In particular if the clearance information assumes a negative value, that is to say that the user is not authorized, the authentication information can provide information about whether the user is authenticated, that is to say is known and has identified himself using a correct password. This permits the user to be provided with feedback about his authentication in the absence of authorization. By way of example, this allows inadvertent input errors to be detected, since in this case a user is not authenticated. However, this also allows the user to be provided with feedback about the fact that although he is known, he is not authorized, for example on account of absent registration or other permission problems.

The container supplicant may in particular be an 802.1X supplicant. The authorization server may in particular be an 802.1X authorization server. The container management component may in particular be a container management daemon. As a result, it is possible to have recourse to known components for authenticating and/or authorizing users, which are for example provided by the known IEEE 802.1X system. Redevelopment of such components or additional provision can thus advantageously be avoided. In particular, such systems are often already present in establishments such as companies or high schools, for example in order to ensure port-based access control. Accommodating such systems to the method described herein typically requires only little effort.

The method can in particular comprise the following step:
container authentication data being generated on the basis of the container or a container image of the container.

This means that the container can also be subjected to separate authentication. This allows stipulation of which containers can be executed, and the execution of other containers can be prevented.

A container image may in particular be a code that is available on a computer or another unit and by means of which the container is generated or executed. The container can therefore be generated using the container image, for example. The container image can be downloaded from a provision server, for example.

The method can in particular comprise the following step:
the container authentication data being transmitted to the authorization server.

As a result, the authorization server can use the container authentication data for the decision regarding whether the clearance information is set to a positive value or to a negative value.

The authorization request can in particular contain the container authentication data. This permits the container authentication data to be transmitted to the authorization server particularly easily. The container authentication data can also be transmitted to the authorization server in a message that is separate from the authorization request, however.

According to one embodiment, the method can comprise the following steps:
a nonce being received from the authorization server, and
the container authentication data being altered on the basis of the nonce before the container authentication data are transmitted to the authorization server.

The nonce can in particular be received by the container management component and/or by the container supplicant. These can also make the alteration. Such a procedure permits a challenge-response method to be implemented. The nonce can for example be appended to the container authentication data and/or taken into consideration when calculating a checksum. This can be understood as alteration. As a result, it is possible to guarantee that only the container management component or only the container supplicant can transmit the container authentication data in such a way that they are detected as valid by the authorization server. Any tampering or the transmission of such data from a unit that does not know the nonce could be detected by the authorization server.

The container authentication data can in particular be determined as a checksum for the container or for the container image. This produces a value that can distinguish containers from one another and that allows any alterations to a container to be identified. A nonce mentioned earlier can also be included. An example of calculation of a checksum for a container instead of just for a container image would be resource access by a specific container that can at least be configured in Docker by users (e.g. “Container A can use only one CPU core”). The calculation of a checksum for the container may also be the calculation of a checksum for the container image, however.

The checksum can be calculated after the user authentication data are received, for example. In particular, this can relate to reception of the user authentication data by the container management component. As a result, the checksum can be calculated directly prior to the intended use of the container. The risk of any later changes to the container or to the container image before it is executed can be minimized thereby.

According to one embodiment, the container authentication data are an identification number of the container. Said identification number may be predefined for any container, for example. It is then advantageously possible to dispense with calculating a checksum.

In particular in this case, but also generally, the container management component may be configured to guarantee a unique association between identification number and container. This shifts the guaranteeing of the trustworthiness of the container to the container management component, which typically has a high level of reliability anyway.

According to a preferred embodiment, the method further comprises the following step:
container authentication data being generated as a checksum for the container or for a container image of the container, wherein the authorization request contains the container authentication data.

This means that, in addition to the user authentication data that are supposed to uniquely identify a user, it is also possible for the container or the application to be authenticated. This can for example prevent the container or the application from being executed after they have been inadvertently or maliciously altered. The checksum can in particular be created instantaneously or ad hoc when the method is performed, which means that it is current, in principle, and later modification of the container or the application is no longer possible, or such modification would be detected and would lead to execution being denied.

The authorization server preferably determines the clearance information at least on the basis of the container authentication data. This can in particular be done in addition to the user authentication data. The authorization server could use the container authentication data, in particular could use the checksum, to detect any modification of the container or of the application and therefore guarantee that the application is executed only if it has not been altered in comparison with an intended version. The clearance information can in particular assume the negative value or be set to the negative value by the authorization server if the authorization server determines from the container authentication data that the application or the container has been altered.

The authorization server can in particular compare the container authentication data with a number of container preset values and set the clearance information to a positive value only if the container authentication data are consistent with one of the container preset values. The container preset values can therefore be used to stipulate which containers or types of containers can be executed. They may be stored on the authorization server or obtained externally.

If the nonce already mentioned earlier is used, the authorization server can also calculate a checksum on the basis of the nonce and a container image or container that is available to it. This allows the comparison for whether the container authentication data have been received from a unit that knows the nonce. Alternatively, there may for example also be checksums stored in the authorization server that are associated with respective nonces.

The authorization response can in particular contain permission information, wherein the application is executed with rights that are stipulated on the basis of the permission information. This can for example be used to allocate different rights to different users that have different user authentication data. By way of example, certain users can be granted access to certain resources, but others denied access. The permission information can in particular be stipulated by the authorization server, for example on the basis of the user authentication data and/or the container authentication data.

The method preferably further comprises the following step:
a network address being allocated to the container.

This allows the container to be uniquely identified, which in particular allows a data stream to or from this container to be clearly delimited from data streams to or from other containers or other components. This allows the allocation of certain rights for this data stream. The network address may in particular be an IPv6 address, other addresses also being able to be used depending on the implementation.

The network address can in particular be allocated by the container management component. To that end, said container management component can access suitable address ranges, for example. The authorization request can contain the network address, for example. This means that further units, for example the container authenticator mentioned later, can be informed about the network address. Alternatively or additionally, the container management component can also send the network address separately from the authorization request. This can be done in a separate message or communication, for example.

The authorization request can in particular be transmitted to the authorization server via a container authenticator. Similarly, the authorization response can in particular be received from the authorization server via the container authenticator. The container authenticator is typically an additional component that is separate, for example in terms of software and/or in terms of hardware, from the component that executes the container and the authorization server. The container authenticator can perform additional tasks, which are described in more detail later by way of illustration. In particular, the container authenticator may be an 802.1X authenticator, which simplifies recourse to an existing 802.1X system and avoids extensive redevelopment.

The method preferably further comprises the following steps:
the container authenticator generating network clearance information on the basis of the authorization request and/or the authorization response, and
the container authenticator transmitting the network clearance information to a network control component,
wherein the network control component enables or blocks data traffic to and/or from the container on the basis of the network clearance information.

The method can in particular further comprise the following steps:
the container authenticator generating network clearance information on the basis of the authorization response, and
the container authenticator transmitting the network clearance information to a network control component,
wherein the network control component enables or blocks data traffic to and/or from the container on the basis of the network clearance information.

This allows the data traffic from and/or to the container to be monitored, as a result of which the data traffic can also be controlled on the basis of authenticated and/or authorized users. By way of example, access to certain resources or certain types of data traffic can be enabled for certain users but disabled for others. The network control component may for example be a firewall or an SDN controller, the network control component typically being distinguishable, in terms of software and/or in terms of hardware, from the other components already mentioned and/or mentioned below. It may also be a server or another computer.

Such an implementation is an extension of the authentication and authorization by configuration of a network control component.

According to a preferred embodiment, the authorization server generates the authorization response using network clearance data. The container authenticator can in particular generate the network clearance information on the basis of the network clearance data. This can be done in the form of identical acceptance of the network clearance data or following modification. The authorization server can therefore also be used to configure the network control component. This facilitates the configuration.

The authorization server can in particular generate the network clearance data on the basis of the user authentication data and/or the container authentication data. This allows users or containers to be examined individually, and specific rights can be allocated.

The network control component may in particular be arranged such that all data traffic to and from the container and/or to and from a protected server is routed through the network control component. This allows the data traffic to and from the container or to and from a protected server to be monitored completely. By way of example, the container can be shielded thereby and/or the container can be equipped with certain access rights, which can be controlled by the network control component. A protected server, which may be present in the network, for example, can moreover be particularly protected against unauthorized access. A protected server may in particular be a server that stores particularly sensitive information, or information worthy of protection.

The network control component may also be a gateway that connects two networks. By way of example, it may be a gateway between a local area network and the Internet. As a result, it is for example possible to stipulate that only the container or only specific containers can communicate with the Internet, whereas other network elements can communicate in the local area network only.

The container authenticator can preferably transmit the network address allocated to the container to the network control component. The network address can be obtained by the container authenticator by way of the authorization request or a separate message, for example. The network control component can then in particular enable or block the data traffic on the basis of the network address. This is useful in particular because the network address can be used to uniquely identify the container and hence rights can be reliably stipulated and supervised for the data traffic of this container.

The network address can in particular be transmitted from the container management component to the container authenticator. This permits simple communication of the network address.

A protected communication channel passing through the network control component can in particular be formed between the container and a network element. This allows a multiplicity of attacks to be prevented. By way of example, the network element to which the protected communication channel is formed may be a protected server to which only one specific container or multiple specific containers has or have access.

The protected communication channel may in particular be end-to-end encrypted. This allows concurrent reading by unauthorized parties to be prevented.

The protected communication channel may in particular be a VPN (virtual private network) channel. By way of example, IPsec can be used as the VPN technology. This has been found to be advantageous for applications of this kind. Other techniques can also be used, however.

The authorization server can preferably deliver information and/or keys for setting up the protected communication channel to the container supplicant. This means that, in addition to the information already mentioned or in addition to the functionality already described, the authorization server can provide information such as in particular keys for the protected connection. This allows particularly simple and reliable provision of such information and keys and also joint management on the authorization server.

The information and/or keys for setting up the protected communication channel may in particular be contained in the authorization response. To this end, they can be included in the authorization response by the authorization server. This allows the authorization response to be easily used to provide such information. Separate provision is also possible, however.

The network clearance information can in particular configure the network control component to let through only data traffic to and from the container or multiple containers. This can be used for example if the network control component is a gateway between two networks. By way of example, one network can be shielded from another network, for example the Internet, in order to prevent unauthorized access. By way of example, in this case just one container or multiple containers can obtain the permission to take their respective data traffic through the network control component, that is to say for example to access the Internet. This allows a protected browser for secure environments to be implemented, for example.

Data traffic between the container and one or more other network elements can in particular be provided via a protected and/or encrypted network. This allows a multiplicity of possible attacks to be prevented. The protected and/or encrypted network may in particular be encrypted by means of MACsec. This has been found to be advantageous for typical applications, other embodiments also being possible.

According to a preferred embodiment, the container is configured to execute only one application. This can increase security further, since each container is associated with only one application, and vice versa. This also in particular allows containers with associated applications to be provided centrally, with users or other persons being prevented from executing additional applications in the respective container that may violate guidelines or security requirements. This can in particular be understood to mean that it is not possible to execute two or more applications in the container.

The method preferably further comprises the following step:
the application and/or the container being downloaded from a provision server.

This means that containers and/or associated applications can be provided centrally, for example within an establishment such as a company or an educational institution. The container is more preferably configured to execute only applications downloaded from the provision server. This can guarantee that only approved applications are executed, which can avoid security problems. The execution of only approved applications and/or containers can in particular also be guaranteed by the checksum already mentioned earlier and the associated processing.

The authorization request and/or the authorization response are preferably EAP messages or EAPoUDP messages. It is possible to have recourse to the known EAP protocol, which avoids additional administrative effort or development work. Such messages have been found to be advantageous for performing the method.

The container may in particular be a remote application container (RAC).

An aspect of the invention moreover relates to a network arrangement configured to carry out a method as claimed in one of the preceding claims. The network arrangement has a first computer unit, which is configured to execute the container management component, the container and the container supplicant, and a second computer unit, which is configured to execute the authorization server. The computer units are networked to one another for data traffic. This applies to the computer units mentioned here and to further computer units. In regard to the method, it is possible to fall back on all of the embodiments and variants described herein.

A computer unit may in particular be a physically definable computer or for example also a virtual machine on a computer or on a server farm. Networking can be effected by wire or wirelessly and in particular provide a defined interface for data traffic.

The network arrangement may in particular be configured to perform the method using a container authenticator. It may in particular further have a third computer unit, which is configured to execute the container authenticator.

The network arrangement may in particular be configured to perform a method using a network control component. It may further have a fourth computer unit, which is configured to execute a network control component.

According to one embodiment, the network control component may be a gateway between the network arrangement and a network that is separate therefrom. This means that for example it is possible to monitor a data traffic between a local area network, or specific network, and the Internet, as described earlier. Internet access can be limited to specific containers, for example.

According to one embodiment, the network arrangement may have a protected server that is addressable only via the network control component. This means that suitable configuration of the network control component, for example as described earlier, allows access to the protected server to be controlled, for example in such a way that only one container or specific containers has or have access to the server.

In regard to the method to be implemented for the respective components or computer units, it is possible to fall back on all of the embodiments and variants described herein.

An aspect of the invention moreover relates to an electronic device, such as for example a computer, that is configured to perform a method according to an aspect of the invention. An aspect of the invention additionally relates to a nonvolatile computer-readable storage medium containing program code that, when executed, results in a processor performing a method according to an aspect of the invention. In regard to the method, it is possible to fall back on all of the embodiments and variants described herein.

### BRIEF DESCRIPTION OF THE DRAWINGS

The implementation disclosed herein and principles in this regard are described below with reference to the accompanying drawing, in which:

FIG. 1: shows a comparison of system virtualization and container virtualization,

FIG. 2: shows a Docker architecture,

FIG. 3: shows a port-based authorization model from 802.1X,

FIG. 4: shows a communication example of authentication and authorization based on 802.1X,

FIG. 5: shows a comparison of protocols,

FIG. 6: shows a managed host that executes an RAC application and an operating system application,

FIG. 7: shows an accommodation of 802.1X for the performance of a method according to an aspect of the invention,

FIG. 8: shows a data model,

FIG. 9: shows a data flow,

FIG. 10: shows a further data flow,

FIG. 11: shows a test environment,

FIG. 12: shows a network configuration of Docker in the test environment,

FIG. 13: shows a two-step authorization process, and

FIG. 14: shows experiments for assessing the communication between the managed host, an RAC and two web servers.

### DETAILED DESCRIPTION OF THE PREFERRED EMBODIMENTS

In general, it should be mentioned that container virtualizations can be implemented at operating system level. By way of example, they provide virtualized operating system environments that are isolated with regard to hardware resources and security. They typically share an operating system kernel and can contain libraries, which are needed in order to execute one or more contained applications.

Containers that can be used for the purposes of the method described herein can also be referred to as xRACs. By way of example, only specific applications with their dependencies and configurations can be contained in a container. Examples of container platforms are Docker, Kubernetes, systemd-nspawn, BSD Jails, Linux Containers, Windows Containers, Solaris Containers, Virtuozzo and rkt. Docker has been found to be particularly advantageous for the method disclosed herein.

Virtualization facilitates efficient and flexible use of hardware resources, increases security through isolation and ensures error tolerance and scalability through simple migration processes. In comparison with complete operating systems, containers additionally have the advantages described below. Owing to the shared operating system, containers require fewer CPU, memory and hard disk resources. Container images are much smaller, which facilitates distribution over numerous recipients. Containers simplify application distribution. Instead of having to provide support for complex combinations of applications, dependencies and user configurations, administrators are able to provide containers that are tested beforehand. Additionally, containers have no boot times, making them seem advantageous in particular for applications that are required only briefly.

FIG. 1 compares the concepts container virtualization and system virtualization. Virtual machines (VMs) in the system virtualization are typically operated on virtualized hardware components of a hypervisor system and emulated components. The hypervisor monitors isolation with regard to resources and security. VMs operate complete operating systems containing all of the binary components and databases for executing applications.

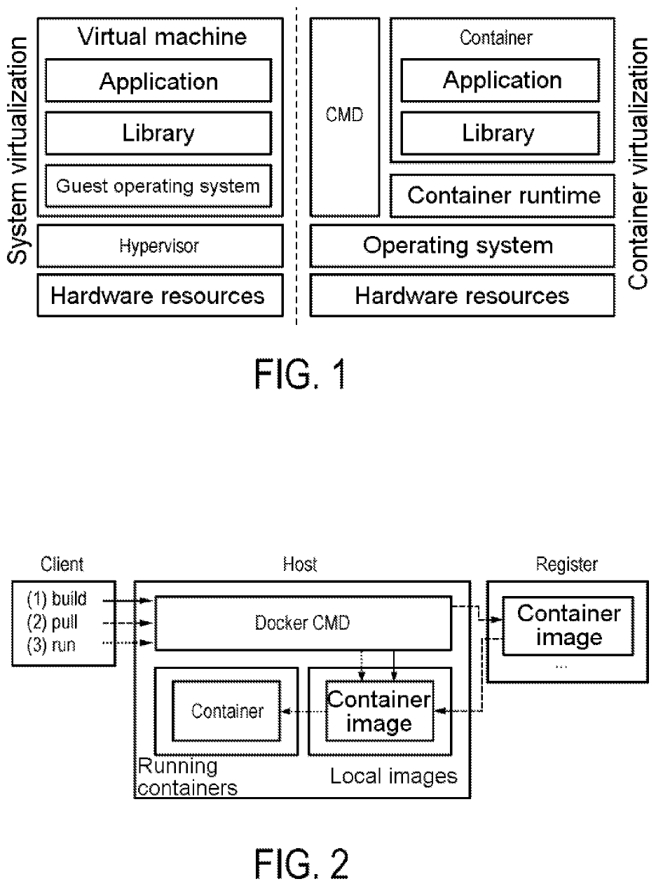

One of the commonest container platforms is currently Docker. FIG. 2 shows a simplified overview of the Docker platform and its operation. A host with a shared operating system (OS) contains the Docker CMD (container management daemon), which generates and manages containers and container images. Container images are write-protected templates that contain applications with their dependencies, such as for example binary components, databases and configurations. Containers are runtime instances that extend the write-protected container images by a layer that can be written to. Different container instances can therefore split a shared image. This results in scalability with low hard disk requirements. The Docker CMD is controlled by the Docker client via a REST interface. The Docker client may be arranged in the host, which also contains the Docker CMD, or in a remote host. A Docker command line interface (CLI) is an example of user control by means of CLI calls. The Docker CMD can be connected to Docker registers, which permit users to upload or download (push or pull) container images. Such registers are either privately or publicly available. A Docker hub containing more than 100 000 container images is an example of the latter. Shared operations are build (1), pull (2) and run (3). Build allows users to generate individual container images. Pull allows users to download existing container images from a Docker register, in order to become part of the local container image memory. Run can be used to execute container images from the local image memory on the host system. A Docker register can also be referred to as a provision server.

Docker uses various functions of the operating system kernel to provide isolation and resource limitation, and supports memory drivers such as for example AuFS, OverlayFS and ZFS, in order to allow stacking of a file system. A container format and a runtime environment of Docker were adopted as open industrial standards by the Open Container Initiative.

Container security platforms extend the container management daemon (CMD) by security functions. By way of example, Twistlock and the Aqua Container Security platform allow a runtime environment based on machine learning mechanisms for constantly supervising containers to detect compromising behavior and specific network firewalls to filter container traffic. The Sysdig Secure platform permits the formulation of service specifications, for example specifications based on applications, containers, hosts or network activities. The platform delivers alarms and actions based on infringements of specifications, event logging and current events. The Atomicorp Secure Docker kernel is a hardened Linux kernel that provides security-relevant features such as outbreak prevention, memory alteration prevention or prevention of direct user access through the kernel. All of the platforms are focused on supervising and monitoring possibly unreliable containers that are executed on a shared container runtime environment. Features for authenticating and authorizing (AA) users, containers and their network flows are not part of these platforms, however.

The Docker authorization framework has been part of Docker since version 1.10. It extends the Docker CMD by a REST interface for external plug-ins for authorization. Requests from the Docker CMD, for example in order to start a container, are forwarded to a plug-in for authorization, which contains mechanisms for deciding whether the request is permitted or denied. The Docker authorization framework implements no security functions but provides a basis for implementing such security concepts. The method disclosed herein further extends this.

Containers typically provide applications or services without a graphical user interface (GUI) that run in a cloud or on a data center infrastructure. Examples are containers containing web applications with their requirements, for example an nginx web server with a PHP runtime and MySQL database.

The text below provides a description of 802.1X and an explanation of how it can be used to support authentication and authorization (AA). EAPoUDP is also presented, which is an alternative protocol for data traffic for AA in 802.1X. A summary of how AA for applications is currently executed in practice is provided.

IEEE 802.1X introduces port-based network access control in wired Ethernet networks. Nevertheless, today it is known primarily from wireless 802.11 networks. One example is eduroam, which is an amalgamation of wireless campus networks from universities. Subscribers can connect to the Internet, specifically regardless of whether they are at their home university or at another university.

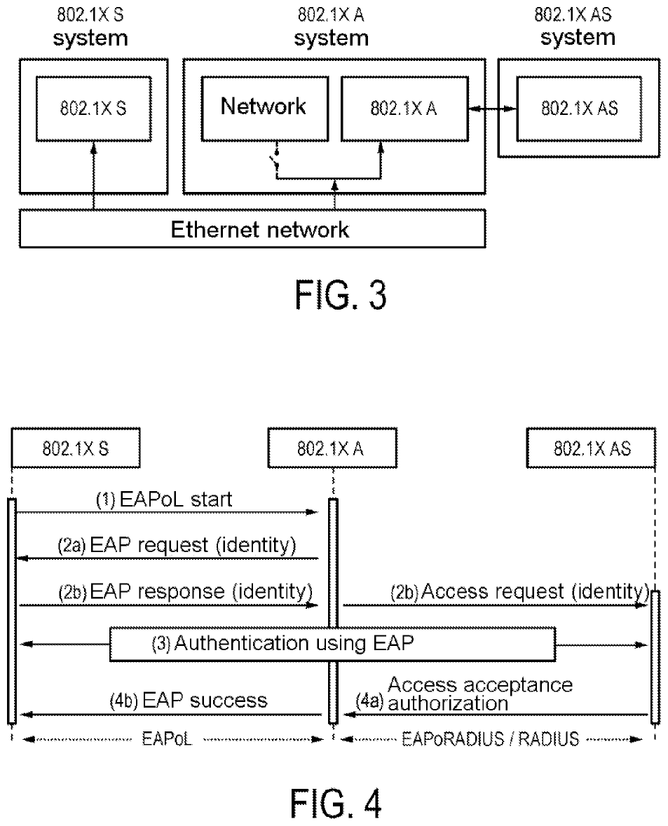

FIG. 3 shows the three components of 802.1X and the principle of port-based network access control. A supplicant system is a network host that contains the 802.1X supplicant (802.1X S); an authenticator system contains an 802.1X authenticator (802.1X A) and controls network access by network hosts. Examples are access switches that connect network hosts to the main network. Prior to authorization, the supplicant system can reach the 802.1X A, but not the network. In the present case, an 802.1X AS (authorization server) is an authentication, authorization and accounting server, for example. It stores authentication data for checking user identities and authorization data for permitting access to the network. It authenticates the 802.1X S and delivers authorization information to the 802.1X A.

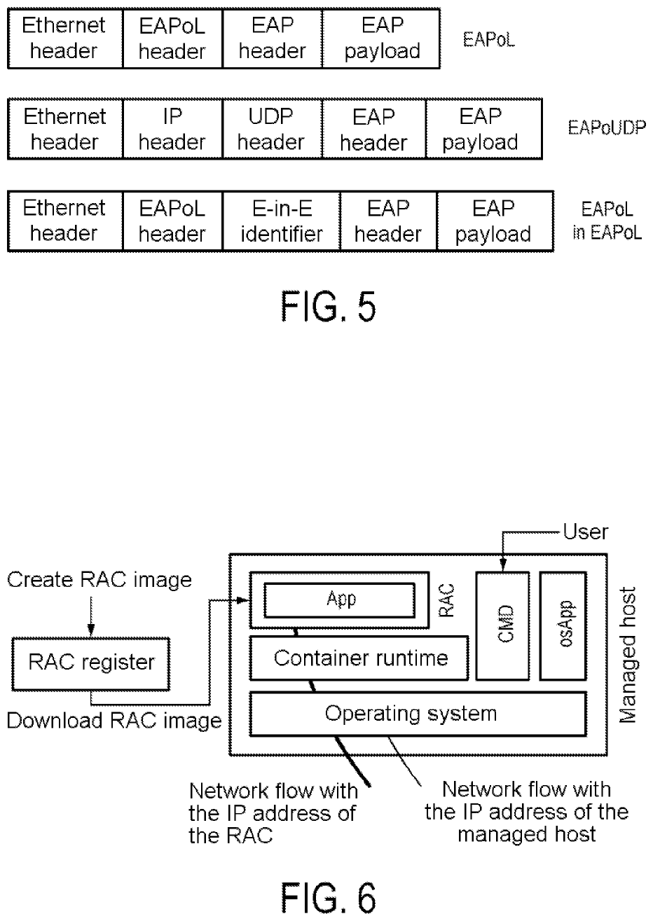

802.1X extends the Extensible Authentication Protocol (EAP) and the Remote Authentication Dial-In User Service (RADIUS) for interchanging AA data. Both have provision for fixed request and response schemes, specifically for interchanging AA data. The Diameter protocol is a less common alternative. Authentication data are transmitted in Ethernet frames as EAP-over-LAN (EAPoLAN) encapsulation between the 802.1X S and 802.1X A and as EAP-over-RADIUS (EAPoRADIUS) between 802.1X A and 802.1X AS. FIG. 5 shows the packet structure of EAPoL. Authorization data are transmitted in RADIUS frames between the 802.1X AS and the 802.1X A.

Details of 802.1X are explained using a four-step approach by AA as shown in FIG. 4. In a first step (1), 802.1X S initializes the authentication by transmitting an EAPoL starting message to the 802.1X A. In a second step, the 802.1X A requests the identity from the 802.1X S (2a) and forwards it to the 802.1X AS (2b). RADIUS supports large domains containing multiple hierarchically organized RADIUS servers. Every identity is linked to a domain and known to the RADIUS server of this domain, which means that AA attempts in RADIUS infrastructures can be forwarded. In a third step (3), authentication is carried out, specifically between 802.1X S and 802.1X AS. The authenticator encapsulates EAP packets from EAPoL frames and encapsulates them again as EAPoRADIUS frames, and vice versa. The flexible message structure of EAP permits the use of different authentication procedures. Simple approaches support identity information in plain text or simple MD5-hashed passwords, but more secure authentication procedures such as EAP Tunneled TLS and EAP-TLS are also supported. The authenticator passes only EAP messages. New EAP types must therefore be implemented only on the 802.1X S and the 802.1X AS, but not in the 802.1X A. In the fourth step, the RADIUS server can return authorization data to the 802.1X A, specifically following successful authentication. This may be coarse-grained, for example a binary access decision regarding whether or not the supplicant system gains access, or fine-grained, for example VLAN tags that are set for expected user traffic or filter rules applied by the authenticator. The authenticator applies the authorization data to the specific physical port of the switch, for example it sets a VLAN tag. The authenticator then confirms successful AA to the supplicant by using an EAP success message (4b).

EAPoUDP is a variation of EAP that permits the transmission of EAP data by way of UDP and IP. FIG. 5 shows the associated packet structure in comparison with EAPoL. In contrast to EAPoL it is possible to use EAPoUDP for authenticating multiple applications running on a network host. It is also possible for UDP packets to be transmitted using any connection technology, or they may even be routed within multi-domain networks. EAPoUDP was introduced as an Internet draft, which ended without standardization in the PANA Working Group at the IETF in 2002.

802.1X specializes in port-based access control for network hosts. In practice, AA for applications is implemented as part of the applications or using the Kerberos AA protocol.

Most network applications implement a type of AA mechanism. Examples are login forms on a home screen, where users are asked to enter valid access information in order to start using an application. Other examples are client certificates, which are used together with TLS, and an infrastructure with a public key. However, AA functionalities that are part of the application have an influence that is restricted to the client and server ends of the network application. Neither the starting of the application nor the network infrastructure in between can be controlled.

Kerberos is a network authentication protocol allowing different authentication for clients and servers via a nonsecure network. Clients are for example complete hosts, users or applications; servers represent hosts providing certain network applications. Kerberos adapts user tickets for authenticating various network applications. Kerberos needs to be implemented by applications at the client and server ends, which prevents use for older applications, which cannot be used.

FlowNAC adds fine-grained SDN network access control systems by using 802.1X for AA for applications on network hosts. This allows different versions of AA for different applications on a network host. To allow different AA for different applications on a network host, EAPoL-over-EAPoLAN encapsulations are introduced. As shown in FIG. 5 in a comparison of data packets for EAPoL, EAPoUDP and EAPoL in EAPoL, FlowNAC adds a different version of EAPoL. An EAPoL-in-EAPoL packet field identifies up to 64,000 different EAP processes, which are transmitted as encapsulated EAP payload. However, this deviation from the old 802.1X requires substantial alterations to 802.1X S and 802.1X A. The 802.1X S is one part of a kernel of an operating system, and the 802.1X A is part of network switches, which means that only open source operating systems and firmwares permit modifications. Nevertheless, it is difficult to perform the modification in new versions of the operating system kernel or the firmware images. EAPoL is relied on in the present case, i.e. AA data transfer is limited to the Ethernet connection. EAPoUDP can likewise be used, in principle. Similarly, FlowNAC adds no IP addresses for applications and the starting of applications by AA is not restricted.

The text below describes RACs (restricted application containers) and the method described herein (xRAC). Additionally, the operation of the control components is explained in detail. Restricted application containers (RACs) are generally executable container images containing a single application, the dependences thereof and configuration data such as program settings and software license information. As can be seen from FIG. 6, RACs are executed in a container runtime environment in parallel with applications inherent to the operating system. The CMD controls the execution of RACs and provides an interface for users to generate, delete and start or stop RACs. Each RAC has its own IPv6 address, which means that the traffic in the network can easily be identified. RAC images are for example generated by network administrators and distributed by way of RAC registers. They are for example either downloaded from such registers by users or automatically synchronized by managed hosts.

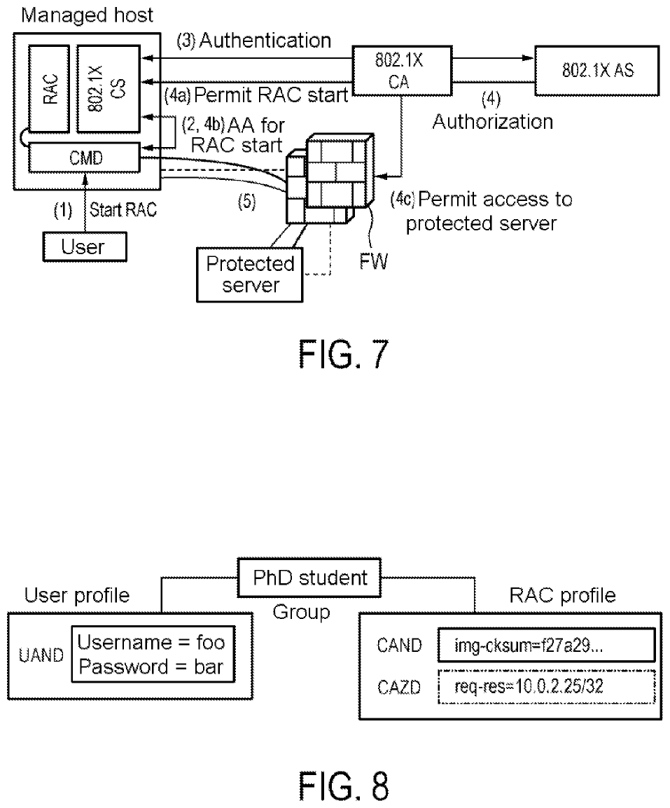

FIG. 7 shows a user who can access a container management daemon (CMD), which is a container management component. The CMD is located in a managed host, which additionally contains a remote application container (RAC) and a container supplicant in the form of an 802.1X CS. These are corresponding software modules. For the purpose of authorization, there is an authorization server 802.1X AS external thereto, said authorization server storing user data and possibly also data about approved applications and/or containers and associated checksums. Between the managed host, or the 802.1X CS contained therein, and the authorization server there is a container authenticator, which is denoted by 802.1X CA. Additionally, there is a firewall FW, which monitors and controls network traffic from and to the managed host. This controls access in particular to a protected server, which is shown at the bottom. The firewall FW is a network control component.

xRAC provides for execution and access control for RACs on managed hosts, for example. An RAC is preferably authenticated and authorized, specifically before execution takes place. FIG. 7 shows an AA process for RACs using 802.1X. First, a user attempts to start an RAC by way of the CMD (1), and the CMD instructs the 802.1X CS for the AA (2). Following successful authentication (3) and authorization, the 802.1X AS responds with authorization data or an authorization response via the 802.1X CA (4) to the 802.1X CS (4a). The 802.1X CS informs the CMD of the fact that the RAC should be started (4b). Additionally, the 802.1X CA informs network control elements of the authorized RAC. In this example, the firewall FW is configured to permit access to a protected server (4c). Other examples are SDN controllers that program SDN switches. The authorized RAC, but not the managed host or other RACs, now communicates with the protected server (5).

AA for RACs introduces two additional advantages in comparison with known application provision and network security. First, AA for RACs limits RAC execution on managed hosts to predefined RAC images and approved users. This permits network operators to guarantee that only current and unmodified RAC images can be executed. This improves computer and network security, since only valid RAC images can be executed on the managed hosts. Additionally, network operators are able to distribute RAC images to managed hosts beforehand, for example by synchronizing their set of RAC images with an internal RAC store in the background. Users therefore have access to all of the available RAC images on managed hosts, but are able to start them only after they have been authorized by AA. Finally, every RAC has a globally standard IPv6 address that can be used to identify data traffic to and from a specific RAC. RAC authorization data on the 802.1X AS contain information about how the data traffic of the RAC is supposed to be controlled by network elements. This permits configuration of network elements or network control components from the authorization server AS.

All in all, the following procedure can therefore be implemented, for example.

First, user authentication data are received from the user by the container management daemon CMD as a container management component. The user authentication data are forwarded to the container supplicant 802.1X CS. Said container supplicant generates an authorization request containing the user authentication data. In a preferred embodiment, it further generates a checksum for the container, the checksum being container authentication data that are also included in the authorization request.

The authorization request is then transmitted to the authorization server 802.1X AS via the container authenticator 802.1X CA. Said authorization server compares both the user authentication data and the checksum against applicable databases. This is referred to as authentication. If it arrives at a positive result, i.e. the user authentication data are associated with an authorized user and the checksum indicates that container and/or application have not been altered, then the authorization server generates an authorization response containing positive clearance information and, if necessary, also containing permission information. The authorization response is returned to the container supplicant 802.1X CS via the container authenticator 802.1X CA. The authorization response is then forwarded to the container management daemon CMD, which, on the basis thereof, ascertains whether an application can be executed, and if necessary with which permissions. If the response is accordingly positive, the container management daemon starts the application and allocates the appropriate permissions thereto. Should the authorization server be unable to authenticate the user, however, or should it certainly be able to authenticate the user but discover that permission is absent, then the authorization server generates an authorization response containing negative clearance information and accordingly returns said authorization response.

Additionally, after the application is started, the container RAC is allocated a unique network address, for example an IPv6 address. This address is communicated to the firewall FW.

Additionally, the container authenticator 802.1X CA notifies the firewall FW of network clearance information for the container RAC, said network clearance information originating from the authorization server 802.1X AS in the form of network clearance data. The firewall FW then controls data traffic from and to the container RAC on the basis of the network clearance information and, in so doing, identifies the container from its IPv6 address. This allows access to the protected server to be controlled, for example. To this end, in the present case, the firewall FW is arranged in such a way that all data traffic from and to the protected server passes through the firewall FW. In particular, it is possible for a protected channel, in particular a VPN channel, to be formed between the container and the protected server. This allows interchanged data to be protected against alteration and unauthorized concurrent reading.

The authorization request from the container supplicant 802.1X CS to the authorization server 802.1X AS therefore contains in particular user authentication data (UAND) and container authentication data (CAND). The authorization server 802.1X AS authenticates the user and verifies the integrity of the RAC image. If the image is valid and the user is authenticated and if the user has permission to execute the RAC, the authorization server 802.1X AS responds to the container authenticator 802.1X CA with authorization data or an authorization response. The decision can be made using a new data model, for example, which is shown in FIG. 8. By way of illustration, said data model has user profiles (1), RAC profiles (2) and groups (3), which define whether a certain user is authorized to execute a certain RAC. User profiles (1) contain user authentication data (UAND), which are used to authenticate the user. Examples are access data, for example username and passwords. RAC profiles (2) contain container authentication data (CAND) and container authorization data (CAZD). The first are used to verify the integrity of the RAC by calculating the cryptographic hash function for the RAC image. CAZD contains all the permissions for an RAC, for example whether it can be started by the requesting user and whether it is entitled to use network resources. This can also be referred to as authorization response. In the example shown, the RAC is permitted to use specified network resources. The AA data of the model described are stored in the authorization server 802.1X AS. The data model is an example that can easily be extended to support other requests. The container supplicant 802.1X CS authenticates RACs with the authorization server 802.1X AS via the container authenticator 802.1X CA. It transmits UAND and CAND to the authorization server 802.1X AS and receives CAZD from the container authenticator 802.1X CA.

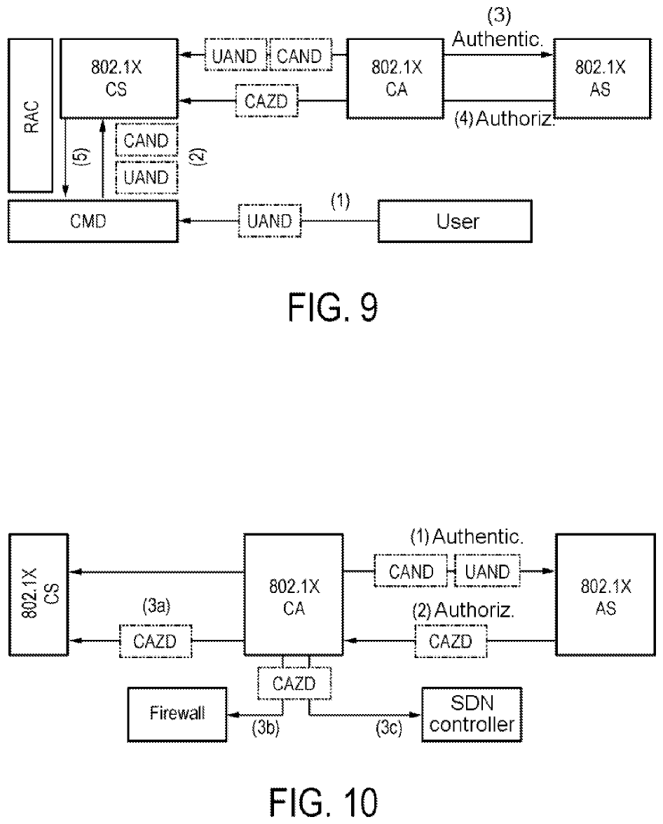

The components managed host, container authenticator, authorization server, firewall and protected server shown in FIG. 7 can be regarded as respective computer units. The whole arrangement is a network arrangement configured to perform a method described herein. FIG. 9 illustrates the process for AA from the perspective of the container supplicant 802.1X CS. Said container supplicant runs on the managed host, provides an interface for the CMD and is configured with the IP address or URL of the container authenticator 802.1X CA, which means that it can initiate AA. At (1), the user asks the CMD to start a specific RAC on the managed host. The request contains UAND. The CMD asks the container supplicant 802.1X CS whether the user can be allowed to do this (2). The request contains UAND and CAND, which are obtained by the CMD, CAND being calculated ad hoc as a checksum for the container RAC or for the container image thereof. The container supplicant 802.1X CS initiates AA by establishing an EAPoUDP session with the container authenticator 802.1X CA. Authorization is then carried out with the authorization server 802.1X AS via the container authenticator 802.1X CA (3). By way of example, in older versions of 802.1X, back-end authentication can be carried out using EAPoRADIUS, with front-end authorization being performed by EAPoUDP. If authorization is successful, the container supplicant 802.1X CS receives CAZD from the container authenticator 802.1X CA (4). The container supplicant 802.1X CS then permits the CMD to start the RAC (5).

The container authenticator 802.1X CA forwards AA data between the container supplicant 802.1X CS and the authorization server 802.1X AS. Further, it informs network control elements of authorized RACs.

In step (1) of FIG. 10, authentication is performed by transporting authentication data between the container supplicant 802.1X CS and the authorization server 802.1X AS using the EAP. The EAP data are transmitted between the container supplicant 802.1X CS and the container authenticator 802.1X CA using the UDP (EAPoUDP) and they are transmitted between the container authenticator 802.1X CA and the authorization server 802.1X AS using RADIUS. It is therefore a task of the container authenticator 802.1X CA to modify the tunnel for EAP data. Further, following successful authentication, the authorization server 802.1X AS returns CAZD to the container authenticator 802.1X CA using RADIUS (2), and the container authenticator then informs the container supplicant 802.1X CS of the successful authorization (3a). Whereas the conventional 802.1X A only opens ports on a switch for authorized devices, the container authenticator 802.1X CA informs general network control elements about authorized RACs. These may be ports on a switch, firewalls (3b) or SDN controllers (3c). The firewall is then programmed in such a way that it lets through all outgoing traffic with the IP address of the RAC, and the SDN controller instructs SDN switches to let through all traffic with the IP address of the RAC, provided that applicable permissions have been granted. More specific flow descriptors are typically not needed, but can be implemented.

Various use scenarios for the approach disclosed here, or the approach according to an aspect of the invention, are described below.

A web browser in high-security environments will first be discussed. This may be relevant to research facilities, state-owned institutions or hospitals, for example, which work with highly sensitive data and need to shield their internal network from the Internet. Web browsers are still needed for various activities, however. It is proposed that web browsers be used as RACs on managed hosts. The isolation of RACs prevents malicious users from abusing Internet access in order to externalize internal information or to contaminate the internal network with infectious downloads. The network flow control of RACs guarantees that only the web browser can reach the Internet. If the data traffic of the RAC is encrypted, for example for DNS requests and website data, network control elements can still carry out packet filtering on the basis of the IP address of the RAC.

Additionally, applications that work with confidential data, for example relating to research activities, medical documentation or public offices, are discussed. This often involves the need to access confidential data on servers. If such applications are provided as RACs on managed hosts as described herein, only legitimate users can access these servers. The isolation feature of the RAC prevents remote hackers from accessing the server. They normally gain system access through gateways provided by a virus or a Trojan horse, such malware normally being picked up via browser downloads or email attachments, which is not possible with RACs. It is further possible for malicious users of legitimate applications to use hacker tools to gain access to the server and to reveal information therefrom, which is not possible in the digital domain with an isolated application. The isolation of RACs prevents malicious users or applications from attacking the server. The network flow control guarantees that the server can be reached only by legitimate RACs and users, but not by other RACs or the managed host itself.

xRAC extends the advantages that are known generally for virtualization and container virtualization and have been described earlier. Additionally, xRAC can guarantee that only valid containers are executed on managed hosts, and that they can be used only by legitimate users. Thus, xRAC performs AA (authentication and authorization) for applications without the need to modify same, which is a particular advantage for older applications. Further, the container authenticator 802.1X CA can configure network control elements such that authorized RACs have access to protected network resources. RACs allow this control because all network traffic of an RAC is identified by a single IPv6 address. This is a particular advantage because networks today have no information about legitimate flow, and numerous application flows can have the same IP address. Applications may even be invisible on account of encryption. Thus, xRAC provides a solution to the serious problem of controlling legitimate traffic. xRAC is flexible in this regard, as it implements software-defined network access control by interacting with other network control elements. In particular, it is not dependent on specific technologies or limited thereto.

A prototype for implementations of xRAC is discussed below.

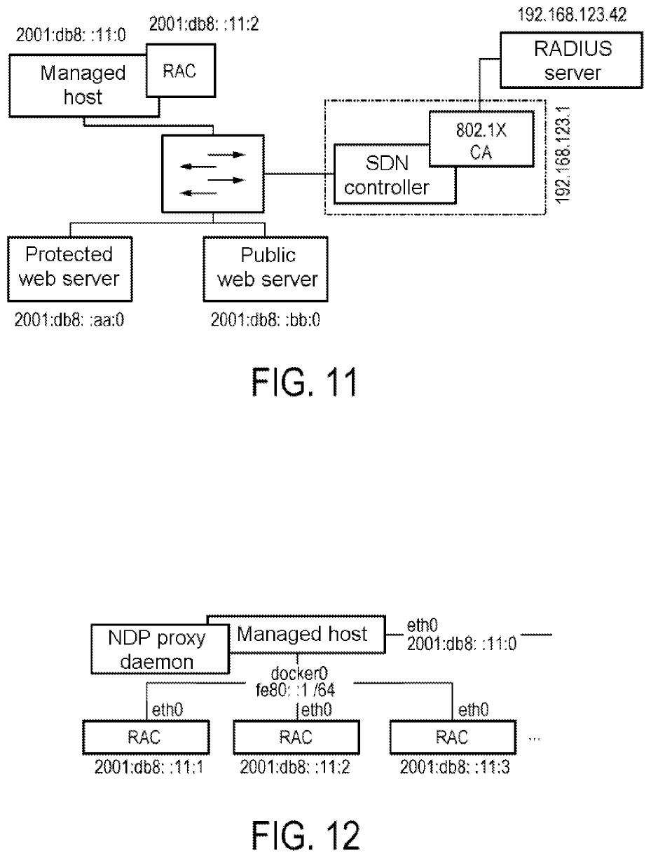

FIG. 11 shows a test environment. The managed host executes RACs. An SDN switch connects the managed host, a protected web server and a public web server and is controlled by an SDN controller. The 802.1X CA runs on the SDN controller as an SDN application that communicates with an 802.1X AS.

Nested virtualization can be used in this case, i.e. a virtual machine (VM) encapsulates all parts of the test environment, including the managed host. This approach permits the whole test environment to be migrated to other hardware platforms. In the present case, KVM hypervisor with QEMU for hardware-assisted virtualization and libvirt for the orchestration was used for a test. The managed host, the two web servers and a RADIUS server run as nested VMs using Ubuntu 17.04. An Open vSwitch is used as the SDN switch, which is controlled by a Ryu SDN controller.

Version 17.05 of Docker is used as the container virtualization platform for implementing RACs in the present case. The Docker CMD is configured such that each RAC receives an IPv6 address that is unique worldwide and can be reached by other network hosts. FIG. 12 shows the network configuration used. By default, RACs receive only a link-local IPv6 address. A fixed IPv6 subnetwork with routable addresses for RACs is therefore set up. In the present case, the managed host is configured with the IPv6 subnetwork 2001:db8::11:0/116, and the RACs receive an IPv6 address from this range. The first RAC receives 2001:db8::11:1 and the second RAC receives 2001:db8::11:2. The Docker daemon automatically adds routes to a routing table of the system and allows IPv6 forwarding, so that all traffic can be routed to the IPv6 subnetwork via a docker0 interface. In order to allow the RACs to be reached by other network hosts, an NDP proxy daemon is used in the present case. This forwards L2 address resolution for IPv6 addresses of the RACs, i.e. it monitors adjacent requests for RAC addresses and responds with an MAC address for the managed host. Packets that address an RAC are then received, and are forwarded to the specific RAC by the Docker host via the docker0 device.

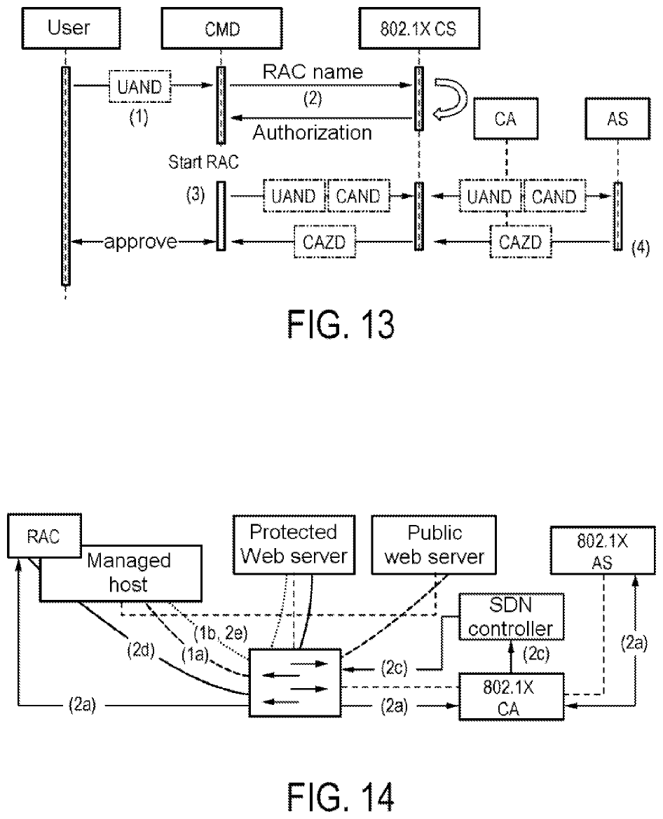

In the present case, the 802.1X CS is implemented as a plug-in for the Docker authorization framework, which has been described earlier. The plug-in is programmed in Python and uses a Flask library for implementing a REST interface. FIG. 13 shows the authorization process. At (1), the user asks the CMD to start a container. The request contains UAND, for example consisting of a username and a password. The Docker authorization framework defines a two-stage authorization process, only the second step being needed in the present case. The first authorization request (2) contains only minimal data, for example the name of the RAC image. Since the present implementation is just based on the second authorization step, the 802.1X CS corresponds to a permission as the default. The second authorization request (3) contains UAND and CAND. The 802.1X CS performs authentication with the 802.1X AS through the 802.1X CA, as described by (3) above. At (4), the 802.1X AS returns CAZD, which is forwarded to the 802.1X CS if AA is successful.

The 802.1X CA is programmed as an SDN application for the Ryu SDN controller in the present case. The 802.1X A, which is known from the prior art, is extended by the addition of support for authentication with the 802.1X CS using EAPoUDP. The 802.1X CA opens a UDP socket on port 5995 and awaits connections from the 802.1X CS. The 802.1X CA can still act as an older 802.1X A, which performs AA for network hosts in the old 802.1X using EAPoL. As an example of network control using xRAC, a limited MAC-learning switch is implemented. This learns MAC addresses of connected hosts, but only forwards packets if the IP addresses of transmitter and receiver are on a whitelist. The whitelist contains static entries, for example for public servers, and dynamic entries, which can be modified by the 802.1X CA after receiving CAZD from the 802.1X AS. The limited MAC-learning switch is implemented by extending the L2 switching SDN application of the Ryu SDN controller framework.

Additionally, the frequently used software FreeRADIUS is used as 802.1X AS, with an AA data model being extended in order to implement CAND and CAZD. In FreeRADIUS, it is possible to implement additional attributes for AA and simple features by using specific attributes, which are defined in the unlang processing language. The defined AA data model can easily be extended and can be modified by adding multiple vendor-specific attributes (VSAs).

Two web server VMs in the test environment operate a Python web server, which delivers HTML files using the HTTP. The protected web server with the static IPv6 address 2001:db8::aa:0 delivers an HTML page with the clause “protected content”. The public web server with the static IPv6 address 2001:db8::bb:0 delivers an HTML page with the clause “public content”.

To demonstrate the functionality, experiments were performed with the test environment described.

The experiments look in particular at the communication between the managed host, a specific RAC, the protected web server and the public web server. A wget tool is encapsulated as the RAC, in order to receive files using the HTTP. In the experiments that follow, the RAC is used in order to request an HTML file from both the protected web server and the public web server. UAND, CAND and CAZD are added on the RADIUS server in order to permit a specific user to execute the RAC and to access the protected web server.

The experiments shown in FIG. 14 are carried out. Before the RAC is executed, it is shown that the managed host can reach the public, but not the protected web server. An ICMP echo request is therefore transmitted from the protected host to the IPv6 address of both the public web server and the protected web server. The public web server can be reached without authorization (1a), but an attempt to reach the protected web server fails (1b). It is now demonstrated that the integrity of RACs is verified during an authentication, i.e. an RAC with a divergent checksum cannot be started. A further RAC image is generated that encapsulates a patched version of wget and attempts to start it, specifically by using the user access data as defined on the RADIUS server. The authorization fails, i.e. the RAC cannot be started on the managed host. It is now demonstrated that the correct RAC can be started and that it can reach the protected web server following successful AA. After a command to start the RAC is entered, said RAC is authenticated and authorized, as described previously (2a). The SDN controller receives CAZD and programs the SDN switch to permit forwarding of packets between the RAC and the protected web server (2c). The RAC is now able to receive the received HTML file from the protected web server. An attempt to retrieve the same HTML file using wget directly from the managed host fails (2e), i.e. the protected web server can be reached by the RAC, but not by the managed host.

In summary, it can be stated that xRAC is proposed, a concept for the performance of access control for restricted application containers (RACs) on managed clients. It involves authentication and authorization (AA) for RACs such that only current RAC images can be executed by approved users. Further, the authorization is extended to protected network resources, specifically such that authorized RACs are able to access them. Data traffic control is simplified by the fact that all traffic of an RAC is identified by its IPv6 address. The architecture of xRAC is presented and a prototype implementation is used to show that xRAC can be set up using standardized technology, protocols and infrastructure. A prototype of xRAC uses Docker as the container virtualization platform for distributing and executing RACs, and signaling based on 802.1X components. Modifications can be made to a supplicant, an authenticator and an authorization server, as a result of which both user and container AA data can be interchanged. Furthermore, the container authenticator is extended in order to inform required network control elements about authorized RACs. xRAC supports software-defined network control and improves network security without modifying core components of applications, hosts and infrastructure.

Mentioned steps of the method according to an aspect of the invention can preferably be performed in the order indicated. A different order is also possible, however, if it makes technical sense. The method according to an aspect of the invention can be performed in one of its embodiments, for example with a particular combination of steps, such that no further steps are performed. Further steps may also be performed in principle, however, even steps that are not mentioned.

It should be pointed out that features in the claims and in the description may be described in combination, for example in order to facilitate comprehension, even though they can also be used separately from one another. A person skilled in the art will see that such features can also be combined with other features or combinations of features independently of one another.

Dependency references in subclaims can denote preferred combinations of the respective features, but do not exclude other combinations of features.

1.-46. (canceled)

47. A method for selectively executing a container that contains an application, the method comprising:
a container management component receiving user authentication data;
the user authentication data being forwarded to a container supplicant;
the container supplicant transmitting an authorization request to an authorization server, wherein the authorization request contains at least the user authentication data;
the container supplicant receiving an authorization response from the authorization server, wherein the authorization response contains at least clearance information that can assume either a positive or a negative value;
the authorization response being forwarded to the container management component;
the container management component deciding whether the container can be executed, wherein the container can be executed if the clearance information has a positive value, and wherein the container cannot be executed if the clearance information has a negative value; and
only if the container can be executed, the container being started and executed.

48. The method as claimed in claim 47, wherein the authorization server determines the clearance information at least on the basis of the user authentication data, and/or wherein the authorization server compares the user authentication data with a number of user preset values and sets the clearance information to a positive value only if the user authentication data are consistent with one of the user preset values.

49. The method as claimed in claim 47, wherein the container supplicant is an 802.1X supplicant, and/or wherein the authorization server is an 802.1X authorization server, and/or wherein the container management component is a container management daemon.

50. The method as claimed in claim 47, further comprising:
container authentication data being generated on the basis of the container or a container image of the container; and
the container authentication data being transmitted to the authorization server.

51. The method as claimed in claim 50, further comprising:
a nonce being received from the authentication server; and
the container authentication data being altered on the basis of the nonce before the container authentication data are transmitted to the authorization server.

52. The method as claimed in claim 50, wherein the container authentication data are determined as a checksum for the container or for the container image.

53. The method as claimed in claim 50, wherein the container authentication data are an identification number of the container.

54. The method as claimed in claim 50, wherein the authorization server determines the clearance information at least on the basis of the container authentication data, and/or wherein the authorization server compares the container authentication data with a number of container preset values and sets the clearance information to a positive value only if the container authentication data are consistent with one of the container preset values.

55. The method as claimed in claim 47, wherein the authorization response contains permission information, wherein the application is executed with rights that are stipulated on the basis of the permission information.

56. The method as claimed in claim 47, further comprising a network address being allocated to the container.

57. The method as claimed in claim 56, wherein at least one of i) the network address is allocated by the container management component, ii) the authorization request contains the network address, and iii) the container management component sends the network address separately from the authorization request.

58. The method as claimed in claim 47, wherein the authorization request is transmitted to the authorization server via a container authenticator, and/or wherein the authorization response is received from the authorization server via a container authenticator.

59. The method as claimed in claim 58, further comprising:
the container authenticator generating network clearance information on the basis of the authorization response; and
the container authenticator transmitting the network clearance information to a network control component,
wherein the network control component enables or blocks data traffic to and/or from the container on the basis of the network clearance information.

60. The method as claimed in claim 59, wherein the authorization server generates the authorization response comprising network clearance data, and
wherein the container authenticator generates the network clearance information on the basis of the network clearance data.

61. The method as claimed in claim 60, wherein the authorization server generates the network clearance data on the basis of the user authentication data and/or the container authentication data.

62. The method as claimed in claim 59, wherein the network control component is arranged in such a way that all data traffic to and from the container and/or to and from a protected server is routed through the network control component.

63. The method as claimed in claim 59, further comprising:
a network address being allocated to the container,
wherein the container authenticator transmits the network address allocated to the container to the network control component, and
wherein the network control component enables or blocks the data traffic on the basis of the network address.

64. The method as claimed in claim 59, wherein the network clearance information configures the network control component to let through only data traffic to and from the container or multiple containers.

65. The method as claimed in claim 47, the application and/or the container being downloaded from a provision server,
wherein the container is configured to execute only applications downloaded from the provision server.

66. A network arrangement configured to carry out a method as claimed in claim 47, the network arrangement comprising:
a first computer unit, which is configured to execute the container management component, the container and the container supplicant; and
a second computer unit, which is configured to execute the authorization server, wherein the computer units are networked to one another for data traffic.
